(19) United States
(12) Patent Application Publication
(10) Pub. No.: US 2014/0372023 A1
(43) Pub. Date: Dec. 18, 2014

(54) Navigation Method And System With Centralised Server

(71) Applicant: Pierre Hayot, Clermont-Ferrand Cedex (FR)

(72) Inventor: Pierre Hayot, Clermont-Ferrand Cedex (FR)

(21) Appl. No.: 14/345,160

(22) PCT Filed: Sep. 14, 2012
(86) PCT No.: PCT/IB2012/001833

§ 371 Date: Jun. 2, 2014

(30) Foreign Application Priority Data
Sep. 15, 2011 (FR) FR 1102798

(51) Int. Cl. G01C 21/36; G01C 21/20

(52) U.S. Cl. CPC G01C 21/36; G01C 21/20
USPC 701/430

(57) ABSTRACT

Navigation system (1) comprising a centralised server (10) having access to roadmapping data (19), and a plurality of mobile navigation modules (40), capable of communicating at least temporarily with the central server (10) to exchange data, in which the centralised server (10) comprises a navigation window generation module (14) enabling the route data to be formatted into a plurality of successive fixed windows, each corresponding to one or more route instructions and an exit detection data generation module (15), and in which the mobile navigation devices (40) comprise a route exit detection module (47), enabling the possible exits from the intended route to be detected during the movement of the mobile device.

### TECHNICAL FIELD OF THE INVENTION

The present invention relates to a navigation system and method comprising a centralised server having access to roadmapping data relating to at least one given geographical zone and capable of relating to a plurality of mobile navigation devices provided to receive the route data produced by said server.

### PRIOR ART

Navigation methods and systems operating with the aid of mobile devices are well known and have even become commonly used tools for a considerably large number of road users. Most of the current devices are stand-alone and non-communicating, and therefore comprise all of the useful mapping data for calculating routes and displaying maps on which the routes are shown. Given the substantial quantity of data to be processed and retained, these devices require substantial capacities in terms of both memory and the microprocessor used. In addition to their complexity and high cost, this type of device has the disadvantage of containing data which quickly become outdated if no update is carried out. Finally, a stand-alone device cannot in any case supply data to be used in real time, such as, for example, traffic-related data.

To avoid these disadvantages, some suppliers have developed centralised systems in which a central server performs the route calculations for a huge community of users. The data, furthermore comprising roadmaps, are then transmitted from the server to the mobile device. An implementation of this type entails the exchange of substantial volumes of data, incompatible with a bandwidth which is very limited for each receiver, in particular at certain locations or times. Furthermore, the display of the route in the form of a roadmap with a large quantity of information has the disadvantage of burdening the user too intensely, often in order to obtain information which is irrelevant with regard to the route to be followed.

The document WO 98/45823 describes a navigational aid system comprising a mobile terminal connected to a centralised server, and more particularly the means necessary to convert a portable telephone into a navigational aid system. The route requests from the mobile terminal are transmitted to a centralised server via a radio link, and the server, containing the required mapping data and instructions, calculates the requested route and transmits to the mobile terminal the data concerning the segments of straight lines and arcs forming the route, in order to enable real-time guidance. The server evaluates the possibility of the vehicle deviating from its route, also calculates and transmits the possible deviation route segment data in a proximity zone around the main zone. In this document, the route deviation is based on a detection zone involving numerous delimitation points, thus increasing the quantities of data to be transmitted to the mobile terminal.

The document EP 1139317 describes a method for the “off-board” navigation of a vehicle in which, following the introduction of a required destination on the basis of the vehicle starting position, the central server calculates a route to be followed between the starting position of the vehicle and the required destination. This route to be followed is transmitted by the server to the vehicle in the form of successive movement points which must be encountered along the path to the final destination. Prior to the transmission to the vehicle of the data of the route to be followed, the central server tests the quantity of data to be transmitted, and when a predetermined value is exceeded, a partial shortened route is determined on the basis of the calculated complete route, the data quantity of which does not exceed the predetermined value, the transmitted partial route comprising at least the first movement points of the route to be followed and a rough description of the road path. The document presents a route defined by beacon points and a summary description of the overall route.

Thus, in a general manner, the existing methods are not ergonomic and generally make intensive use of memory capacity. The invention provides different technical means to overcome these different disadvantages.

### DESCRIPTION OF THE INVENTION

To start with, a first object of the invention consists in providing a navigation system and method enabling operation with very little data in the mobile device.

A different object of the invention consists in providing a navigation system and method with optimised ergonomics, simplifying understanding and use, in all reliability.

A different object of the invention consists in providing a navigation method enabling the provision of constantly and regularly updated data.

A further different object of the invention consists in providing a navigation method enabling the provision of useful information in real time, even when the bandwidth available for a receiver is very limited.

To do this, the invention provides a navigation system comprising a centralised server having access to roadmapping data relating to at least one given geographical zone and enabling a plurality of routes to be determined in this zone, and a plurality of mobile navigation modules, capable of communicating at least temporarily with the central server to exchange mapping and/or route data, in which the centralised server comprises:
at least one microprocessor;
at least one working memory;
a data exchange module;
a route calculation module;
a navigation window generation module, enabling the route data to be formatted into a plurality of successive fixed windows, each comprising one or more route instructions;
an exit detection data generation module, enabling exit detection data (points or zones) to be generated, enabling an exit detection module of a mobile navigation device to detect a possible exit from the route according to the real position of said mobile navigation device during the movement to travel the intended route;
   and in which the mobile navigation devices comprise:
at least one microprocessor;
at least one working memory;
a data exchange module, to receive the data from a route server;
a navigation module, to provide the transmission to the user of the successive navigation windows according to the real position of said mobile device;
a geolocation module, enabling the real position of the mobile navigation device to be determined during the movement of the latter;
a matching module, enabling a correspondence to be established between the real position supplied by the geolocation module and the intended route;
a route exit detection module, enabling the possible exits from the intended route to be detected during the movement of the mobile device.

A system of this type enables the route data to be formatted in a particularly compact manner, by retaining only the data which are really useful for understanding and following the route. An implementation of this type furthermore enables numerous and frequent exchanges between a server and a plurality of mobile navigation devices without resulting in a heavy consumption in the communication networks used. Furthermore, the preparation of the routes in the form of successive navigation windows enables a considerable reduction in the memory capacity and power required to transmit, store and/or use the route data. Thus, a greater number of devices, even low-powered devices, are capable of carrying out the method. The use of navigation windows instead of roadmaps helps to simplify the reading and understanding of the instructions to travel the route. The removal of the conventional roadmap and its replacement with directional elements and geometric representations of the relevant sections enable a particularly pared down representation of the route to be obtained. For the user, who is not looking for a faithful representation of the physical reality, but rather an easy-to-interpret directional guide, a synthetic route such as the one proposed results in few or no disadvantages. Furthermore, a very large part of the mapping details presented on the detailed maps is imperceptible from the vehicle when following the route. The removal of these details does not therefore interfere with the following of the route when the vehicle moves.

In one advantageous variant, the exit detection data generation module determines a plurality of checkpoints on the calculated route.

In a different variant, the exit detection data generation module determines a plurality of route exit points provided outside the route, particularly in zones comprising sections allowing an exit from the intended route.

According to one advantageous embodiment of the invention, the server furthermore comprises a manoeuvring point detection module, provided to identify the manoeuvring points along the route.

According to a further different advantageous embodiment, the server comprises a direction data availability testing module, provided to check, for each identified manoeuvring point, whether direction-following data are provided in the available roadmapping data.

The invention also provides a navigation method for a navigation system comprising at least one centralised server having access to digital roadmapping data relating to at least one given geographical zone and enabling a plurality of routes to be determined in this zone, and a plurality of mobile navigation devices, capable of communicating at least temporarily with the central server to exchange mapping and/or route data, comprising the following steps:
receiving, in a route server, the data (departure point and arrival point) enabling a route to be determined;
calculating, in the central server, with the aid of a route calculation module and mapping data of at least one zone, at least one route on the basis of the received data;
arranging, with the aid of a navigation window generation module, the route data in a plurality of successive fixed windows, each comprising one or more route instructions;
determining, with the aid of an exit detection data generation module located in the central server, exit detection data (points or zones) enabling an exit detection module of a mobile navigation device to detect, according to the real position of said mobile navigation device during the movement to travel the intended route, a possible exit from the route;
transmitting the navigation window data and the exit detection points to the mobile navigation device concerned, with the aid of the data exchange modules;
displaying, with the aid of a display module of the mobile navigation device, during the movement of the latter along the intended route, the successive navigation windows, according to the real position of said device;
monitoring, with the aid of an exit detection module of the mobile navigation device receiving the real-position data from a geolocation module, a possible exit from the intended route.

For the route portions for which a direction indication is available in the roadmapping data, the extracted direction data enable the creation of particularly pared down navigation windows, without the mapping conventionally used to present the route. Guidance data which are quickly perceptible by the user, simple to interpret, and with a practical implementation offering high reliability are thus obtained, due to the fact that the user instinctively follows the directions according to the names of places or sites readily visible on the road signs present along the route. Moreover, the direction data are numeric data generally requiring a few kilobytes only. The corresponding data files therefore require a considerably smaller memory space than conventional route files comprising mapping data (generally in the form of map images) of the entire zone or region or route travelled. Reduced-data route files of this type can easily be managed from a centralised server, then transmitted via a non-wired network to a very large number of mobiles travelling on the corresponding road network, without involving an excessive consumption of the technical resources of the data transfer network.

The fact of using very concise route data enables a great flexibility in the methods of presentation to the user. The route data can easily be presented on a screen (even of small size), projected onto the windscreen of a vehicle, or with the aid of spectacles serving as a projection medium, by voice synthesis, etc. The route data comprise the essential elements for following the route. The removal of numerous visual elements of a purely aesthetic nature simplifies the reading, avoids any distraction of the driver/user, and thus helps to improve road safety. The route data comprise a succession of fixed navigation windows corresponding to one or more instructions. The instructions are preferably supplemented by an indication of the distance (a duration, a distance, a datum relating to the distance or gap between the navigation device and the next instruction) still to be travelled until the next instruction. This mode is provided with fixed windows, unlike the dynamic guidance mode, in which a rolling mapping background progresses gradually, generally from the top to the bottom of the screen in such a way as to represent the progress of the vehicle along the route.

An instruction preferably comprises a direction datum to be followed (sign or sign extract) or a manoeuvring pattern.

According to one advantageous embodiment, if a direction datum exists in the mapping data, the instruction comprises the direction datum (town, region, exit number, road, cardinal point, etc.), otherwise the instruction comprises a manoeuvring pattern. In one variant, more precise checkpoints are provided close to the manoeuvring points.

According to a different advantageous embodiment, the route exit detection step comprises a series of successive tests based, on the one hand, on the current position of the mobile module and, on the other hand, on route exit points distributed along the intended route.

According to a further different advantageous embodiment, the route exit detection step comprises a series of successive tests based, on the one hand, on the current position of the mobile module and, on the other hand, on a test zone (buffer zone), along the intended route. A test zone extends over a given distance around sections of the route, preferably forming a corridor within which the mobile device is considered to be following the intended route.

The matching between the coordinates received from a geolocation device and the route is preferably carried out in such a way as to indicate, on the windows of the successive steps, the position of the mobile navigation device on a schematic representation of the route.

In an advantageous manner, the schematic representations of the route portions of the navigation windows are multi-scale with possible deformations of certain sections in relation to the original mapping representation.

### DESCRIPTION OF THE FIGURES

All the implementation details are given in the description which follows, supplemented by FIGS. 1 to 11, presented only as non-limiting examples, and in which:

FIG. 1 is a schematic representation of a centralised navigation system according to the invention;

FIG. 2 is a functional flow diagram showing the main steps of a navigation method according to the invention;

FIG. 3 is a functional flow diagram, complementing that of FIG. 2, showing additional steps of a preferred embodiment of the invention;

FIGS. 4 to 6 show examples of navigation window models according to the invention;

FIGS. 7 to 11 show examples of route data in the form of navigation windows for a route between Mantes la Ville and Arcangues.

### DETAILED DESCRIPTION OF THE INVENTION

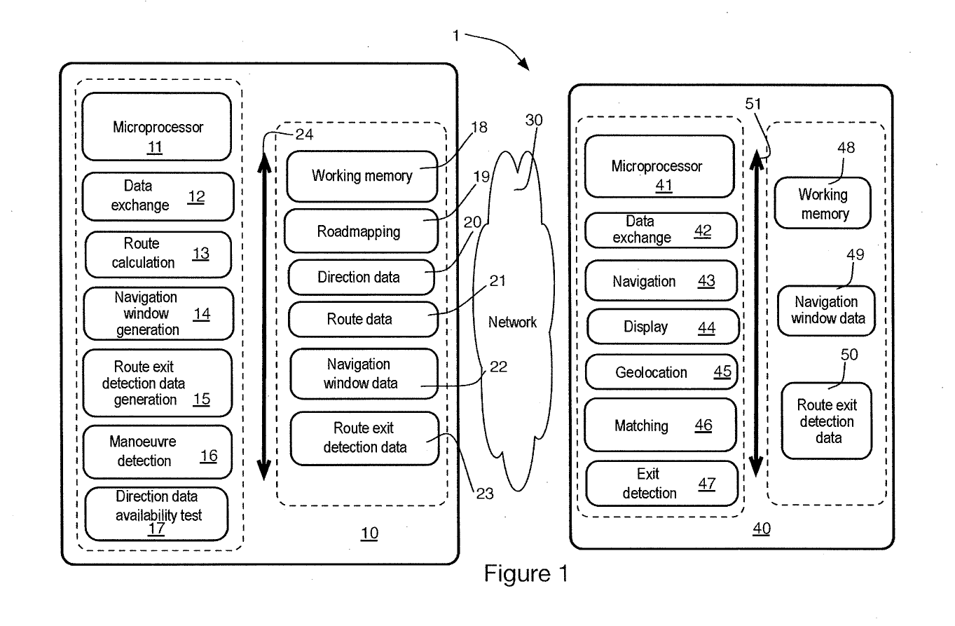

FIG. 1 shows an example embodiment of a navigation system 1 according to the invention. It shows, on the one hand, a route server 10, provided to generate all the data relating to the route for which a route must be produced and navigation carried out. The route server 10 comprises at least one microprocessor 11, for the execution of processor instructions or specifically provided commands, a data exchange module 12, capable of receiving and transmitting data with a plurality of mobile navigation devices 40. Furthermore, the data exchange module 12 enables the reception of route requests from mobile navigation devices 40 with departure and arrival point data, and the transmission to a mobile navigation device 40 (or the requesting device or one or more other devices) of the data produced by the server 10. A means of communication, transfer or data exchange or command, for example a bus 24, is provided to perform the required exchanges between the microprocessor 11 and the different modules.

The route server 10 comprises a route calculation module 13 operating in a manner known per se, with the aid of an algorithm for determining the shortest path between two points, such as Dijkstra or the like. An algorithm of this type, with the aid of a microprocessor and the required processor instructions, enables the exploration of a very large number of possibilities (from several tens or hundreds for low-density zones and/or for short routes, to several hundreds of thousands, or more, for high-density zones of routes and/or for long routes) with the aim of choosing an optimum route according to given criteria, such as the shortest route, or the fastest route etc.

Once the route is known, a manoeuvring point or instruction point detection module 16 allows the manoeuvring points along the route to be detected, i.e. the points or zones where manoeuvres must be carried out to enable the intended route to be followed. A manoeuvre is mainly understood to mean a vehicle-driving action enabling a different section to be selected or not when the driver is faced with a possibility of committing his vehicle to a plurality of sections (at least two). The driver is faced with multiple possibilities for continuing his route, and a manoeuvre enables him to commit his vehicle according to the direction intended by the pre-established route. Thus, the module 16 travels a virtual path of the route produced by the module 13, and identifies the points or nodes where multiple sections are joined. It may involve an intersection of routes, exits or entrances on motorways, and junctions, etc. The manoeuvring points are determined in a manner known per se. For a roundabout, it is understood that a plurality of simple manoeuvres are generally involved, from the entry to the roundabout, then to the passing of each exit, each time involving a manoeuvre consisting either in remaining on the roundabout or leaving it, until the actual exit from the roundabout. In the present document, roundabouts are considered as a single manoeuvre, of the “take the 3^{rd} exit” type, actually consisting in a complex manoeuvre, as previously described, or of the “turn left” type, considering the entire roundabout as a single intersection of a plurality of roads.

The route server 10 also comprises a navigation window generation module 14 designed to generate a succession of windows comprising navigation data corresponding to instructions capable of enabling the route to be followed in a reliable manner. The windows are generated from the direction data to be followed and/or geometry data of manoeuvres or manoeuvring patterns. The data are arranged according to the order of the manoeuvres to be carried out in order to travel the previously calculated route. In one preferred embodiment of the invention, each of the instructions to continue driving comprises at least one indication of a distance still to be travelled until a next instruction. The distance may be expressed in various ways, such as, for example, by a duration, a distance, a datum relating to the distance or gap between the navigation device and the next instruction, etc. An instruction is presented either by means of direction data to be followed, or by geometry data of manoeuvres or manoeuvring patterns.

The route server 10 furthermore comprises a direction data availability testing module 17. This direction data testing module 17 is designed to check, in the roadmapping databases 19, the manoeuvring points for which direction data to be followed are available in the database. These data mean, for example, that one or more road signs indicating a relevant direction are present along the route concerned. This test is preferably carried out upstream of the route generation, in order to enable a specific processing according to the results of the test. Thus, if direction data are available, they are used to make up the navigation windows. If no direction datum is available for one or more manoeuvring points, the method provides, for these manoeuvring points, a step of geometric reconstruction of the useful sections illustrating the manoeuvres enabling the route to be followed. In order to carry out the test, the direction data testing module 17 reviews all of the manoeuvring points detected for a given route in order to determine whether the roadmapping data do or do not include direction data to be followed. In practice, these data are often presented for the major arterial roads such as the motorways or national roads. They may be available in a more substantial manner if they are obtained by an automatic image processing system capable of recognising the signs in order to extract the data from them, on the basis of panoramic photographs captured in a systematic manner by specially equipped vehicles, or by other equivalent means. The fact that the direction data test is carried out by the server allows all users to benefit from centralised updates of the roadmapping databases.

When a plurality of direction indication possibilities exist, it is preferably provided to prioritise the direction most in-phase with the route, i.e. a direction corresponding to a location through which the route passes or close to which the route passes and which is the most distant on the route among the potential locations. In a different embodiment, if the information is available, the most known direction is retained. In a further different embodiment, the direction which is the shortest to write is retained. In a different variant, in the absence of signs, if the next road passes through one or more localities, the most distant locality through which the route passes is retained.

The availability testing module takes action in a distinct manner, according to the results of the tests carried out. Thus, if direction data are available, these data are extracted in order to generate navigation windows. If direction data are not available, the availability testing module constructs, on the basis of the roadmapping data, a geometric model of the road sections to be covered to travel the route. Thus, specific route elements are obtained according to the results of the tests carried out by the direction data availability testing module. In one alternative embodiment, the availability testing module uses pre-designed pictograms to represent schematically the manoeuvres for which the directions to be followed are not available. In a different alternative embodiment, when the direction is known and the space on the screen is limited, the direction is displayed at the expense of the manoeuvring pattern, otherwise the manoeuvring pattern is displayed. In a different alternative, if no direction data are available, only the next path is indicated (as, for example, in FIG. 6, left-hand side).

The route server 10 furthermore comprises a route exit detection data generation module 15. When these data are used by a mobile navigation device 40, they enable it, without the need to have all of the sections of the route, to identify either passage points on the route in such a way as to control the passage to the intended location and the correct following of the route, or points outside the route via which a mobile device would be capable of passing in the event of exiting the intended route. In both cases, the points enable a possible exit from the route to be detected. In such an eventuality, a corresponding warning is transmitted to the server, in such a way as to enable a new route calculation, either to return to the initial route or to reach the destination via a different route.

The data used by the route server 10 advantageously originate from a roadmapping module or database 19 provided within the route server 10 as shown in the example illustrated, or at a location outside the server which the latter can access if required. Similarly, the routes produced by the server can be retained in a module or database of produced routes 21, provided within the server 10 as shown in the example illustrated, or at a location outside the server which the latter can access if required. The same applies to the direction data, the navigation window data and the route exit detection data, which may be retained in modules or databases of directions 20, of navigation windows 22 and of route exit detection 23 respectively, provided within the server 10 as shown in the example illustrated, or at a location outside the server which the latter can access if required.

A route server 10 is designed to be in communication, for example via the intermediary of a cellular or other telecommunications network, according to requirements, with a plurality of mobile navigation devices 40. Each of the mobile navigation devices 40 has a data exchange module 42, designed to transmit route requests to a route server 10, and to receive in return the data produced by the server 10. The navigation devices 40 comprise, in addition to a microprocessor 41 and at least one working memory 48, a navigation module 43, to enable and manage the transmission to the user of the navigation windows received from a route server 10. This transmission is preferably provided by means of a display on a display module 44. According to the requirements and wishes of the user and/or implementation methods, the route windows may be visualised either prior to the actual implementation of the route on the route for information, or in manual mode, for example by the user scrolling through the windows, for example by sliding his fingers over a suitable touch screen, or in navigation mode with presentation of the data according to the real position of the vehicle. A means of communication, transfer or exchange of data or command, for example a bus 51, is provided to perform the required exchanges between the microprocessor 41 and the different modules.

The mobile navigation device 40 furthermore comprises a geolocation module 45 and a matching module 46 suitable, on the one hand, for receiving the position data from the mobile navigation device 40 and, on the other hand, for establishing a correspondence between the raw position data received from the geolocation device and the positions assigned to the manoeuvring points and/or to the route exit detection points.

An exit detection module 47 finally enables the mobile navigation device 10 to check whether the intended route is or is not correctly followed. The route exit detection data received from the route server 10 enable the exit detection model 47 to control the passage via certain detection points. Two modes of operation are possible. In a first case, the detection points are on the route itself. The fact of ensuring that the mobile device passes via one of these points confirms that the intended route is correctly followed. In such a case, the points are advantageously provided at locations where route exits are possible or probable, such as following a junction or fork in the road. In the second case, the detection points are outside the route, preferably at locations where route exits are possible or probable, such as following a junction or fork in the road. A possible indication that the mobile device passes via an exit detection point, for example located after a roundabout, would confirm that the mobile navigation device is no longer on the intended route. In such a case, the mobile navigation device sends a signal or warning to the associated server to enable the latter to determine a different route. A signal or alert can also be transmitted to the user of the mobile navigation device 40 so that the latter can be warned.

In the example embodiment shown in FIG. 1, the data received from a route server 10 by a mobile navigation device 40 are stored in dedicated memory modules or bases, i.e. a navigation window data module 49 and a route exit detection data module 50.

The different server modules 10 and mobile navigation devices 40 previously described are advantageously implemented by means of processor instructions or commands, enabling the modules to perform the operation(s) specifically intended for the module concerned. The processor instructions may be in the form of one or more software programs or software modules implemented by one or more microprocessors. The module(s) and/or software program(s) are advantageously provided in a computer program product comprising a recording means or recording medium usable by a computer and comprising a programmed code readable by a computer integrated into said means or medium, allowing application software to run on a computer or other device comprising a microprocessor such as a navigation device.

According to various alternative embodiments, the microprocessors 11 and 41, just as the working memories 18 and 48, may be centralised for all the modules of the route server 10 or mobile navigation device 40, or may be disposed in an external manner, with connection to the different modules, or may be distributed locally in such a way that one or more modules each has a microprocessor and/or a working memory.

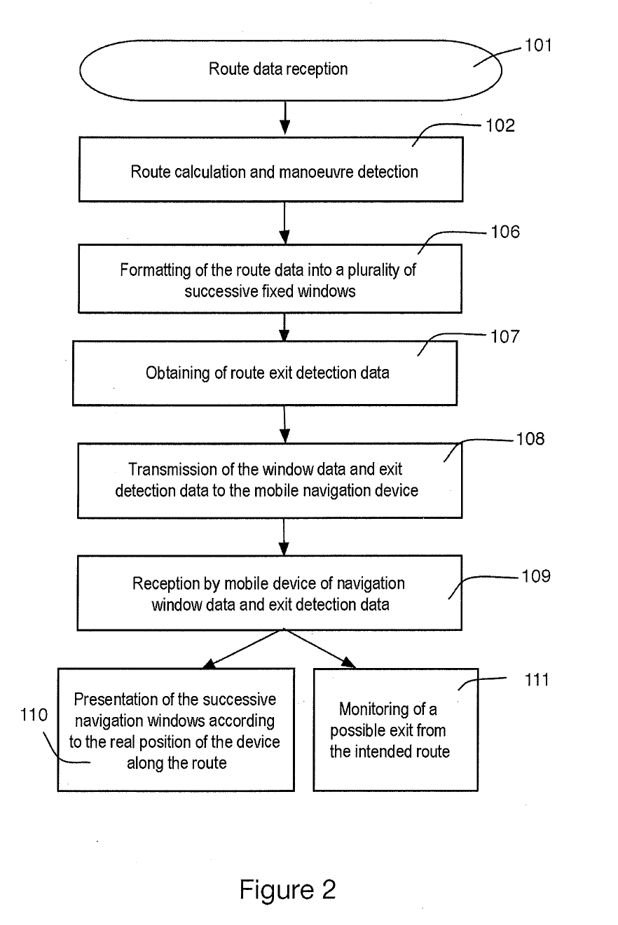

FIG. 2 shows successively the main steps of the method according to the invention. In step 101, the server 10 receives a route calculation request. For example, a user of a mobile navigation device 40 sends a request to the server to which it is connected. The request advantageously comprises data relating to the departure point and the arrival point. These data may also be standardised or already stored by the server. A request may also originate from a third-party manager of routes to be travelled by one or more users. In step 102, the route is calculated by the route calculation module 13. As shown in FIG. 2, this step also comprises a part in which the manoeuvring point detection module 16 identifies the manoeuvring points allowing the previously calculated route to be travelled, as previously described in relation to the module 16. Step 106 provides the formatting of the route data in a plurality of successive fixed windows. “Fixed windows” is understood to mean windows displayed in a static manner, without scrolling, for example, from the top to the bottom of the screen as conventionally used to simulate or represent the movement of the vehicle. The content of the navigation windows is previously described in relation to the navigation window generation module 14. In step 107, the route exit detection data are obtained and possibly stored in the route exit detection data module 23. These data are described above in relation to the module 15 for generating route exit detection data.

In step 108, the data exchange module 12 of the server carries out the dispatch of the useful data to the corresponding mobile navigation device. These data comprise, on the one hand, the navigation window data, and, on the other hand, the route exit detection data. The mobile navigation device receives these data in step 109. Then, in step 110, when the mobile navigation device 40 travels the path along the route, the successive navigation windows are presented according to the real position of the device along the route.

In step 111, which takes place during the period of travelling the route, the exit detection module 47 of the mobile device performs a monitoring of a possible route exit. Thanks to the received route exit detection data, it detects the passage over one or more points located outside the route, for example points located on a road intersecting that of the route, or points located along a detection corridor located on either side of the route. In one alternative, it detects the passage via validation points located on the route. If an exit from the intended route is detected, an exit signal or alert is sent to the associated server to enable a new route calculation, taking into account the exit zone.

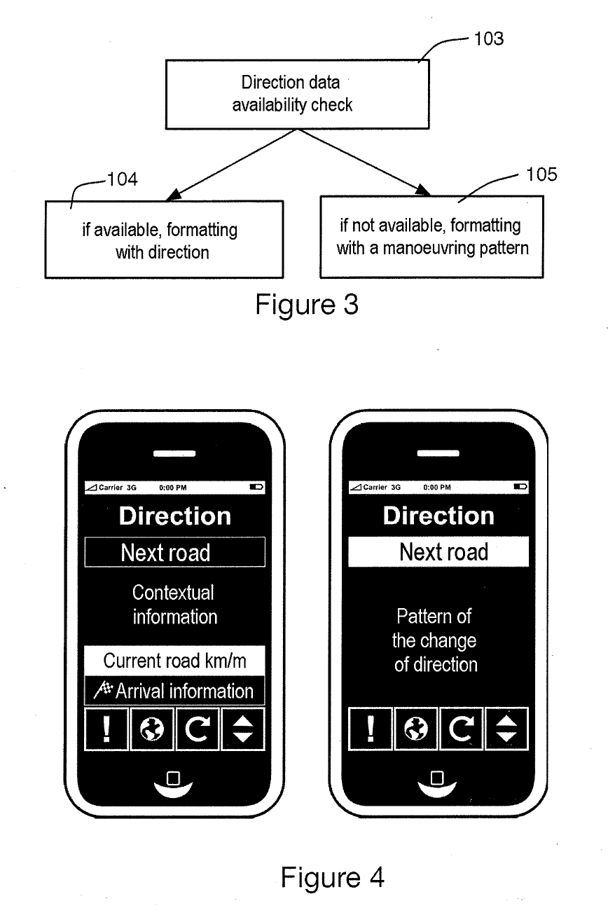

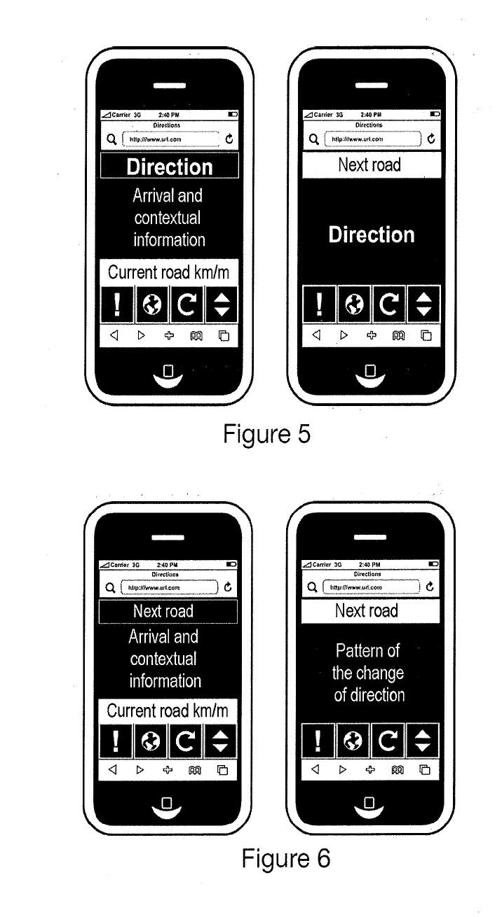

FIG. 3 shows the intermediate steps of the navigation method according to the invention. In step 103, the direction data availability testing module 17 checks the availability of direction data to be followed in relation to the manoeuvring points provided for travelling the route. In step 104, if direction data to be followed have been identified, the window(s) relating to this direction is/are formatted on the basis of these data. In such a case, the guidance instructions supplied to the user include the identified direction, as in the example shown in FIG. 5. The direction data may comprise information relating to the cardinal points. In step 105, if no direction data are identified, a pictogram or manoeuvring pattern is obtained for the corresponding window(s), as shown, for example, in FIG. 6, right-hand side.

FIG. 4 shows an example of a mobile navigation device 40 suitable for the implementation of the present invention. The display module 44 displays the navigation window data. FIG. 4 (example on the left) shows a schematic example of a navigation window, without route data, in which the upper zone of the direction data display module can be seen. In the lower portion of the display module, data relating to the current road (name or number) are displayed, with a distance over which the road is taken before emerging onto a new road or performing a manoeuvre. FIG. 4 (example on the right) shows an example of a navigation window in which a change of road is imminent. The name of the next road (name or number) to be followed is indicated and a manoeuvring pattern illustrating the manoeuvre to be performed is provided. This window remains displayed from the time when the mobile device approaches the manoeuvring point until the time of its completion. The manoeuvre to be performed is advantageously displayed by a symbol summarising its access: to the right, to the left, motorway entry slip road, etc. In the case of aggregated road changes, the pattern of the first manoeuvre to be performed is preferably followed by the name of the last road. This indicates how the complex manoeuvre is undertaken and the road to be taken at the end of the complex manoeuvre.

In practice, the navigation windows are configured to indicate an alternation of instructions according to two main categories, i.e. “continue” and “change continuity”. The expression “continue” does not necessarily mean that the road has no intersections, but rather that a natural continuity of the road, and therefore the absence of a change of direction or forking between branches of equal value, exist. Such a simplification of the guidance instructions presented by the mobile navigation device allows the user not to be constantly troubled as soon as the road to be followed is curved, or for intersections with roads which are irrelevant to the route to be followed.

As shown in the example on the left of FIG. 4, contextual data can also be displayed. This may involve, for example, data relating to:
safety: speed cameras, atypical speeds, dangerous bends, dangerous slopes;
services: hotels, restaurants, filling station, etc;
traffic and/or weather data;
“reassurance” data: close passage, work of art, etc.
tourism data: object to be pointed out on the route or to be suggested for a visit.

The aim of the reassurance data is to inform the user that the mobile device is continuing to progress correctly along the route. Thus, by indicating, for example, a passage close to a place or site that is known or visible from the road where the mobile device is moving, the user has confirmation information relating to the path followed. When a plurality of changes of direction succeed one another at reasonably short intervals, they are advantageously aggregated into a single navigation window comprising a single pattern. The aggregation threshold is, for example, 3 seconds.

As shown in the example in FIG. 4 (example on the left), the display module can also comprise data relating to the expected arrival at the destination. For example, the arrival data may include elements such as the number of kilometres to be travelled before arrival, the time remaining before arrival, the expected arrival time, etc. Other information, such as, for example, a possible delay or additional time linked to heavy traffic on the route, can also be displayed. The displayable elements may possibly be parameterisable by the user.

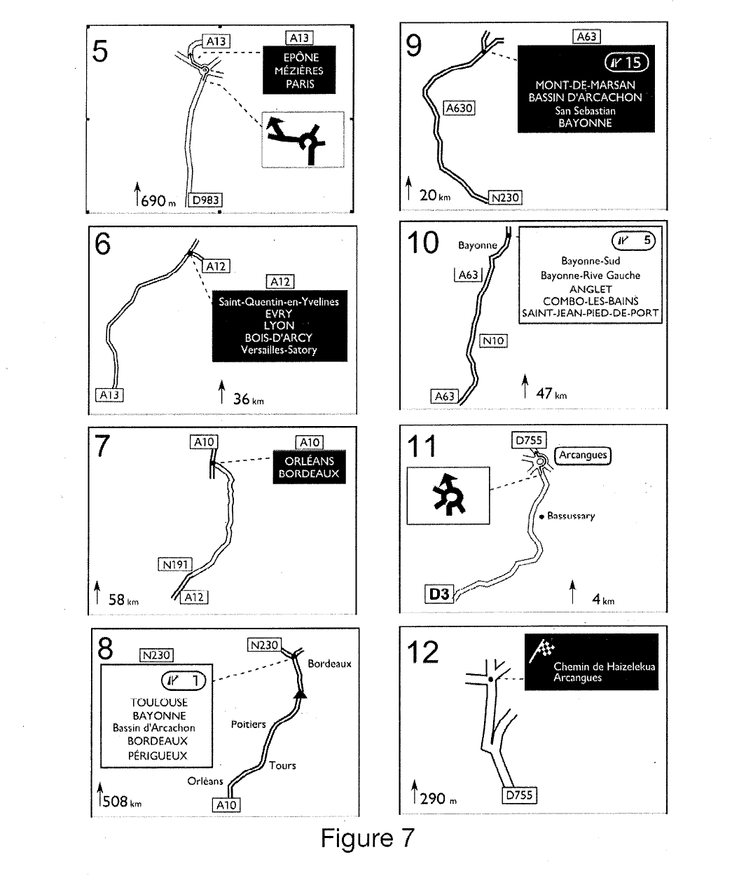

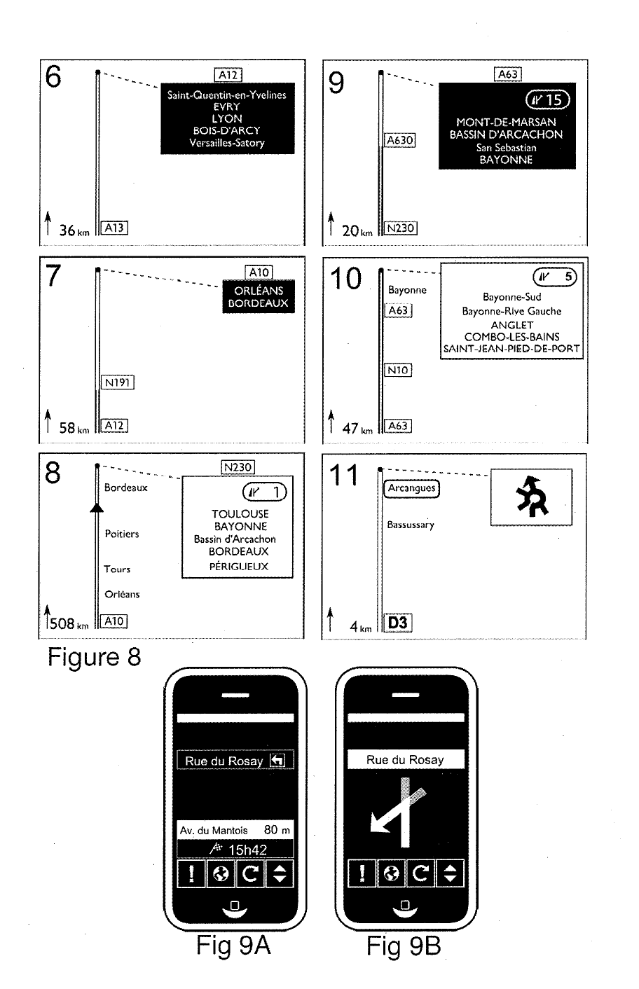

FIGS. 7 and 8 show an example of navigation windows for a route from Mantes la Ville to Arcangues. In navigation window 6 in FIG. 7, the displayed data include the current road (A13), the distance to the next manoeuvring point (36 km) and the direction to be followed (A12 EVRY, LYON, BOIS-D'ARCY). The directions to be followed are advantageously presented with a view representing the visual appearance of the road signs which the user will easily be able to recognise when he is on the road, at the corresponding location. The directions can also be based on the names or numbers of roads, such as, for example, N230 in FIG. 8 (window 8). Finally, the directions can also be based on exit numbers, such as, for example, exit No 1, then No 15 and No 5 in FIG. 8 (windows 8, 9 and 10). A plurality of direction indications can be used in a simultaneous or complementary manner, such as, for example, the motorway A12 and Saint-Quentin-en-Yvelines, thus specifying the route and direction, A10 and Orleans, A63 and exit No 15, etc. The fact of associating a plurality of directional elements enables the user to visually recognise a plurality of signs, thus simplifying the following of the route. The user is furthermore comforted in his driving and avoids wondering unnecessarily whether he has or has not taken the right direction.

In windows 6 to 11 in FIG. 8, a more or less straight virtual route line is defined, with the instruction points distributed along the line. In such a case, the distance to be travelled between two instruction points is advantageously integrated schematically along the route line. In the example shown in FIG. 7, for each of the windows, the corresponding portion of the route to be travelled is illustrated in a schematic manner. The non-adherence to a particular scale enables paths of different lengths to be displayed on each of the windows, according to the manoeuvres. The windows are not therefore structured in relation to a fixed distance to be travelled, but according to the manoeuvres to be performed.

The example shown in FIG. 7 also includes close passage data, such as Orleans, Tours, Poitiers, Bordeaux (FIG. 7 (window 8)). These data do not form part of the data normally available in road databases. They are therefore supplied by way of reference, to enable the user to validate his progression along the route. In the example shown in FIGS. 7 and 8, the reading direction of each of the windows is provided from the bottom to the top of the window, in such a way as to correspond to a representation of the route with the road in front of the vehicle. A representation of this type is very realistic and instinctive and therefore easy to interpret, even with a minimum of data. For example, in FIG. 7 (window 6), the user is informed that he is travelling on the A13 road which he must follow for 36 km by following the direction A12 EVRY-LYON-BOIS D'ARCY, up to the manoeuvring point consisting in taking the A12 road. This window contains two instructions: a first of the “continue” type for 36 km, a second of the “change continuity” type with direction data and without a manoeuvring pattern. Moreover, an arrangement of this type corresponds to an increasingly widespread method, i.e. the visual representation used for GPS navigation devices. In one or the other of these alternatives, a mobile pictogram or point along the schematic road representation can be provided in order to represent the progression of the mobile navigation device along the route portion represented by the current window. Examples are shown in FIG. 7 (window 8) and FIG. 8 (window 8) by a pictogram in the shape of a triangle.

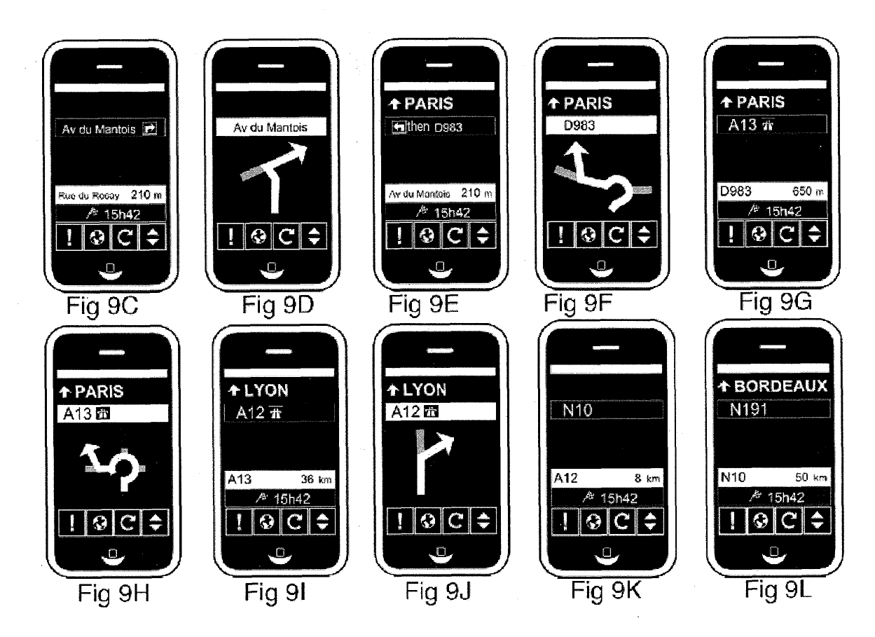

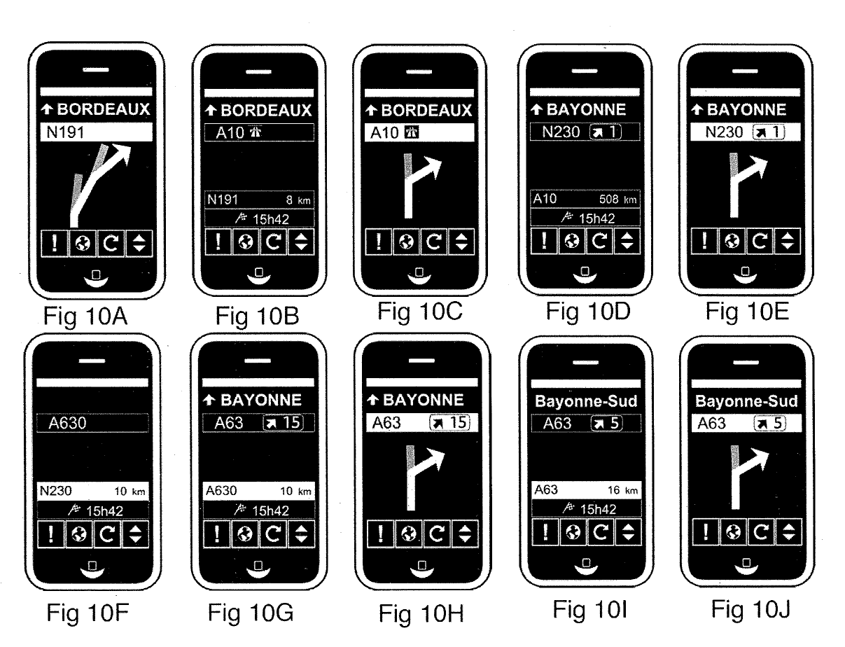

FIGS. 9 to 11 show an example of a route between Avenue du Mantois in Mantes-la-Ville and Arcangues. The following instructions, for example, can be seen for the windows shown in FIGS. 9a to 10a:
Instruction 1 “continue” for 80 metres on Avenue du Mantois (FIG. 9a);
Instruction 2 “change continuity” Turn left into Rue du Rosay (FIG. 9b);
Instruction 3 “continue” for 210 metres on Rue du Rosay (FIG. 9c);
Instruction 4 “change continuity” Turn right into Avenue du Mantois (FIG. 9 d);
Instruction 5 “continue” for 210 metres on Avenue du Mantois (FIG. 9e);
Instruction 6 “change continuity” Turn left then immediately turn right onto D983 (FIG. 9f);
Instruction 7 “continue” for 650 metres on D983 (FIG. 9g);
Instruction 8 “change continuity” Take 3^{rd} exit then immediately turn right onto A13 (FIG. 9h);
Instruction 9 “continue” for 36 km on A13 (FIG. 9i);
Instruction 10 “change continuity” Turn right onto exit to A12 direction LYON (FIG. 9j);
Instruction 11 “continue” for 8 km on A12 (FIG. 9k);
Instruction 12 “continue” for 50 km on N10 (FIG. 9l);
Instruction 13 “change continuity” Turn right onto exit to N191 to BORDEAUX (FIG. 10a).

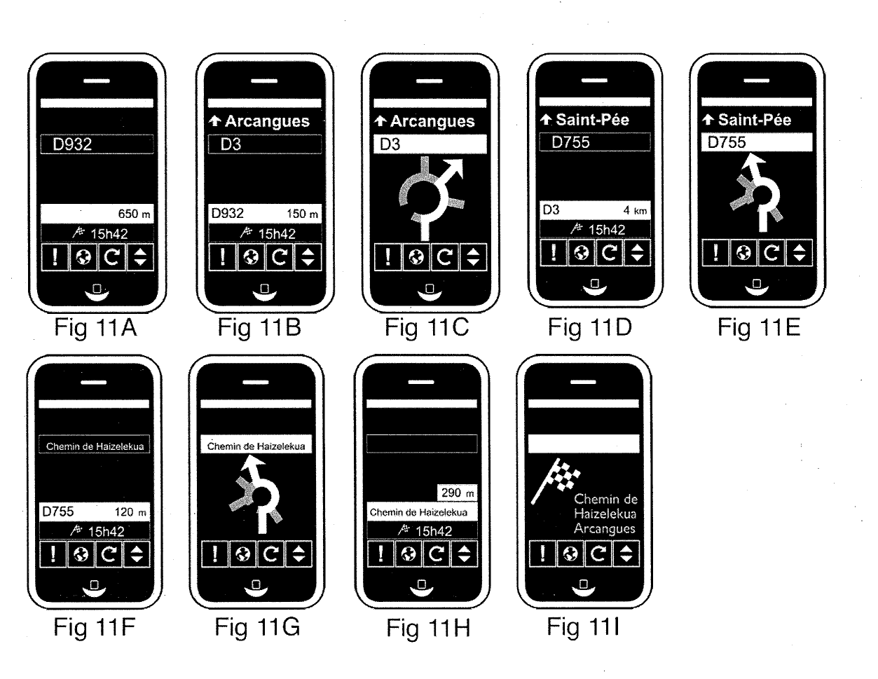

The other windows (FIGS. 10b to 11i) show the other instructions for the continuation of the route.

The figures and their descriptions given above illustrate rather than limit the invention. In particular, the invention and its different alternatives have just been described in relation to a particular example in which the mobile device is integrated into a portable telephone of the “Smartphone” type.

Nevertheless, it is obvious to a person skilled in the art that the invention can be extended to other embodiments in which, as alternatives, the mobile device is integrated into a road vehicle, as a dashboard equipment element.

The reference numbers in the claims have no limiting character. The verbs “include” and “comprise” do not exclude the presence of elements other than those listed in the claims. The word “a/an/one” preceding an element does not exclude the presence of a plurality of such elements.

1. A navigation system comprising a centralised server having access to roadmapping data relating to at least one given geographical zone and enabling a plurality of routes to be determined in this zone, and a plurality of mobile navigation devices, capable of communicating at least temporarily with the central server to exchange mapping and/or route data, wherein the centralised server comprises:
at least one microprocessor;
at least one working memory;
a data exchange module;
a route calculation module;
a navigation window generation module, enabling the route data to be formatted into a plurality of successive fixed windows, each comprising one or more route instructions; and
an exit detection data generation module, enabling exit detection points to be generated, enabling an exit detection module of a mobile navigation device to detect a possible exit from the route according to the real position of said mobile navigation device during the movement to travel the intended route;
and wherein the mobile navigation devices comprise:
at least one microprocessor;
at least one working memory;
a data exchange module;
a navigation module, to provide the transmission to the user of the successive navigation windows according to the real position of said mobile device;
a geolocation module, enabling the real position of the mobile navigation device to be determined during the movement of the latter;
a matching module, enabling a correspondence to be established between the real position supplied by the geolocation module and the intended route; and
a route exit detection module, enabling the possible exits from the intended route to be detected during the movement of the mobile device.

2. The navigation system of claim 1, wherein the exit detection data generation module determines a plurality of checkpoints on the calculated route.

3. The navigation system of claim 1, wherein the exit detection data generation module determines a plurality of route exit points provided outside the route, particularly in the zones comprising sections allowing an exit from the intended route.

4. The navigation system of claim 1, wherein the server furthermore comprises a manoeuvring point detection module for identifying the manoeuvring points along the route.

5. The navigation system of claim 1, wherein the server comprises a direction data availability testing module in order to check, for each identified manoeuvring point, whether direction-following data are provided in the available roadmapping data.

6. Navigation A navigation method for a navigation system comprising at least one centralised server having access to digital roadmapping data relating to at least one given geographical zone and enabling a plurality of routes to be determined in this zone, and a plurality of mobile navigation devices, capable of communicating at least temporarily with the central server to exchange data, comprising the following steps:
receiving, in a route server, data enabling a route to be determined;
calculating, in the central server, with the aid of a route calculation module and mapping data of at least one zone, at least one route on the basis of the received data;
arranging, with the aid of a navigation window generation module, the route data in a plurality of successive fixed windows, each comprising one or more route instructions;
determining, with the aid of an exit detection data generation module located in the central server, exit detection points enabling an exit detection module of a mobile navigation device to detect a possible exit from the route according to the real position of said mobile navigation device during the movement to travel the intended route;
transmitting the navigation window data and the exit detection points to the mobile navigation device concerned, with the aid of the data exchange modules;
displaying, with the aid of a display module of the mobile navigation device, during the movement of the latter along the intended route, the successive navigation windows, according to the real position of said device; and
monitoring a possible exit from the intended route with the aid of an exit detection module of the mobile navigation device receiving the real-position data from a geolocation module, wherein the route exit detection data enables generation module by a mobile navigation device to identify either passage points of the route in such a way as to control the passage of the intended location and the correct following of the route, or points outside the route via which a mobile device would be capable of passing in the event of exiting the intended route, without the need to have all of the sections of the route.

7. The navigation method of claim 6, wherein, for an instruction to be followed, at least one indication of a distance still remaining to be travelled until the next instruction is provided.

8. The navigation method of claim 6, wherein an instruction includes a direction datum to be followed or a manoeuvring pattern.

9. The navigation method of claim 7, wherein, if a direction datum exists in the mapping data, the instruction comprises the direction datum, otherwise the instruction comprises a manoeuvring pattern.

10. The navigation method of claim 6, wherein the route exit detection step comprises a series of successive tests based, on the one hand, on the current position of the mobile navigation device and, on the other hand, on route exit points distributed along the intended route.

11. The navigation method of claim 6, wherein the matching between the coordinates received from a geolocation device and the route is carried out in such a way as to indicate, on the windows of the successive steps, the position of the mobile navigation device on a schematic representation of the route.

12. The navigation method of claim 6, wherein the route exit detection data are obtained from the server and stored in the route exit detection data module.

13. The navigation method of claim 6, wherein in case of detection that the mobile navigation device is no longer on the intended route, a signal or alert is transmitted to the user of the mobile navigation device.

14. The navigation method of claim 6, wherein when the mobile device travels the path along the route, the successive navigation windows are presented according to the real position of the device along the route.
